(19) United States
(12) Patent Application Publication
(10) Pub. No.: US 2014/0378065 A1
(43) Pub. Date: Dec. 25, 2014

(54) METHOD AND APPARATUS FOR SELECTIVELY CONFIGURING A TWO-WAY RADIO DEVICE TO OPERATE IN A CONTROL STATION MODE OR A NON-CONTROL STATION MODE

(71) Applicant: Motorola Solutions, Inc., Schaumburg, IL (US)

(72) Inventors: NAHIYAN ALI, Des Plaines, IL (US); MARK A. HANEY, Huntley, IL (US)

(21) Appl. No.: 13/921,825

(22) Filed: Jun. 19, 2013

(51) Int. Cl. H04B 7/26

(52) U.S. Cl. CPC H04B 7/26
USPC 455/63.1

(57) ABSTRACT

A method and apparatus for operating a two-way radio device includes a receiver front end that has a low noise amplifier (LNA) and an adjustable attenuator coupled to the output of the LNA. The bias provided to the LNA is adjustable in correspondence with a mode selection of either a control station mode or a non-control station mode of operating the two-way radio device. Since changing the bias level of the LNA changes the gain of the LNA, the adjustable attenuator can be adjusted accordingly to maintain a desired gain level for subsequent portions of the receiver front end.

### FIELD OF THE DISCLOSURE

The present disclosure relates generally to radio receivers and more particularly to receivers for two-way radio devices that are used in a control station mode of operation.

### BACKGROUND

Two-way radio systems have been in use for decades, and are still the preferred means of communication in many fields, such as law enforcement, public safety, rescue, and security. The ability to talk and be heard nearly instantly is very important in these fields. Generally, there are three broad categories of two-way radio devices; portable units, mobile units, and control station units. A portable unit is battery powered and generally carried on the user's person, such as on a belt holster. A mobile unit is generally mounted in a vehicle, and is powered by the vehicles electrical system. A control station is generally fixed and is not moved. Each of these three categories have different operating requirement based on their intended usage, and different levels of performance for various radio parameters have been developed over time to optimize devices for operation in each of these three categories. For example, battery life is a critical concern for portable devices, and as such some tradeoffs may be made in radio performance to increase battery life by reducing the power demand of the radio. Conversely, in a control station device, where power consumption is less of a concern, other performance parameters like intermodulation response rejection and linearity of the receiver are emphasized since there is typically a continuous power supply available.

Despite certain two-way radio devices being designed to operate as non-control station device, a number of aftermarket accessory manufacturers have designed accessories that can be connected or coupled to a non-control station two-way radio device so that a user can use the non-control station two-way radio device as a control station. However, due to the design of the non-control station two-way radio device transceiver, it will not have radio performance like that of a two-way radio device that is originally designed to operate as a control station.

Accordingly, there is a need for a method and apparatus for selectively configuring a two-way radio device to operate in a control station mode or a non-control station mode.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a receiver front end for a two-way radio device in accordance with some embodiments;

FIG. 2 is a schematic diagram of a receiver front end for a two-way radio device where an automatic gain control component controls bias and attenuation in accordance with some embodiments;

FIG. 3 is a block schematic diagram of a two-way radio device that can be selectively changed between a control station mode and a non-control station mode in accordance with some embodiments;

FIG. 4 is a schematic diagram of a bias control circuit and an attenuation switch circuit having a common control signal in accordance with some embodiments;

FIG. 5 is a schematic diagram of a bias control circuit and an attenuation switch circuit each controlled by independent control signals in accordance with some embodiments; and

FIG. 6 is a flow chart diagram of operating a two-way radio device and selecting between control station and non-control station modes in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments as exemplified by the teachings herein solve the problem of operating a two-way radio device that has been designed for non-control station operation as a control station by adjusting a bias of an amplifying transistor depending on whether a control station mode or a non-control station mode of operation is selected. In the non-control station mode the bias is adjusted to provide improved sensitivity and better blocking of spurious signal content, and in the control station mode the bias is adjusted to provided better linearity and intermodulation response rejection. To accomplish this, a receiver front end for a two-way radio device includes a low noise amplifier that amplifies signals received via an antenna. A bias adjustment network adjusts a bias of the low noise amplifier responsive to a bias control signal that corresponds to the selected mode of operation. An adjustable attenuator is coupled in series with the low noise amplifier and selectively attenuates an output of the low noise amplifier responsive to an attenuation control signal that corresponds to the selected mode of operation. A controller asserts the bias control signal and the attenuation control signal when the two-way radio device is operated in a control station mode. Asserting the bias control signal causes the bias adjustment network to increase bias to the low noise amplifier, and asserting the attenuator control signal causes the adjustable attenuator to increase an attenuation of the output of the low noise amplifier.

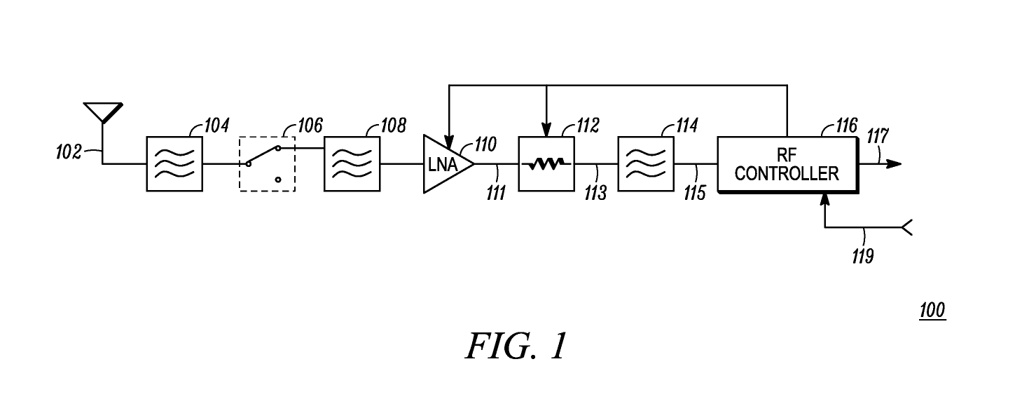

FIG. 1 is a schematic diagram of a receiver front end 100 for a two-way radio device in accordance with some embodiments. The receiver front end 100 can be a direct conversion receiver front end for a receiver line up of a two-way radio device. The receiver front end 100 is switchable between operating modes, where in one mode the receiver front end 100 is better suited for operating as a receiver front end for a two-way radio device used as a control station, and in another mode the receiver front end 100 is better suited for operating as a receiver front end for a two-way radio device used as a non-control station (i.e. in a mobile or portable mode). The change in mode can be made by a user operating the two-way radio device in which the receiver front end 100 is disposed, or a mode shift can be caused by connection (or disconnection) of an accessory that is used for control station operation to the two-way radio device. In a control station mode, the receiver front end has linearity over a wider range of frequencies, and has better intermodulation response rejection (rejection of nearby, non-harmonic signals). In the non-control station mode the receiver has improved receiver sensitivity and can have better blocking (rejection of far out interferences, e.g. non-harmonically related noise).

The receiver front end 100 includes an antenna 102 that collects radio frequency electromagnetic signals from a transmission medium (i.e. air, space). The antenna 102 can be designed to be particularly sensitive to signals in a frequency range of interest. The signals received at the antenna can include signals and noise at other frequencies, so a harmonic filter 104 is used to attenuate non-desired signal content. The harmonic filter 104 is bi-directional, so it also filters transmitted signals to suppress harmonic content. A switch 106 is used to alternatively coupled the antenna 102 and harmonic filter to either the receiver path or a transmitter path (not shown), as is known. A preselector 108 further attenuates signal content outside of the frequency range of interest. The output of the preselector 108 is fed to a low noise amplifier (LNA) 110. The LNA 110 amplifies the filtered signal to produce an amplified signal 111, which is fed to a selective attenuator 112 that can provide different amounts of attenuation, including no attenuation. The output of the selective attenuator 112 on line 113 is then provided to a post filter 114 which can filter out any harmonic or spurious content produced by the LNA 110 to produce a filtered amplified signal 115 that is provided to a controller 116. The controller 116 receives the filtered amplified signal 115, which is still at its originally received frequency, and processes it to produce a demodulated and processed output 117 that is not at a radio frequency, and is in a form that does not require any further frequency-shift processing. The output 117 can contain audio information, such as speech, as well as data, commands, and other information to be utilized by the two-way radio device. The controller 116 provides one or more control signals 118 to the LNA 110 and the selective attenuator 112. A bias control signal is provided to the LNA 110, and an attenuation control signal is fed to the selective attenuator 112. In some embodiments the bias control signal and the attenuation control signal can be independent signals, and in some embodiments they can be a common signal.

The control signal 118 provided to the LNA 110 controls a bias level of the LNA by changing a bias adjustment network (here contained in the LNA 110), and is asserted in correspondence with the selected mode of operation, either control station or non-control station mode. As used here, the term “bias” refers to the direct current (DC) or “steady state” electrical parameters, such as current and voltage, of an amplifying component, such as, for example, a bipolar junction transistor. In general, the “bias” refers to the level of DC current flowing into the base of a bipolar junction transistor. In the non-control station mode the bias current through the amplifying transistor of the LNA 110, is at a low level (relative to the bias level of the control station mode), while in the control station mode the bias is increased to a level above that of the non-control station mode. The higher bias used for the control station mode increases the linearity of the amplifying transistor, and hence the linearity of the LNA 110. The increased linearity provides better intermodulation rejection response. Specifically, increasing the LNA bias current increases the input intercept point of the fundamental frequency with its 3^{rd} order harmonic, known in the art as the IIP3 measurement. Likewise, the 1 dB gain compression point, known in the art as P1 dB, is likewise increased with high bias current. When the IIP3 is sufficiently increased, the intermodulation rejection performance is also increased. However, in addition to consuming more power, the higher bias level used in the control station mode also increases the small signal gain of the amplifying transistor of the LNA 110. As used here, small signal gain refers to the gain determined by the bias, meaning the DC conditions, applied to the amplifying transistor, and assumes that the signal being amplified (e.g. the signal provided to the base of the amplifying transistor) is limited in magnitude such that it does not significantly change the gain of the amplifying transistor. To compensate for the change in gain in the control station mode relative to the non-control station mode, the selective attenuator 112 is controlled to provide higher or additional attenuation in the control station mode over the non-control station mode, responsive to the control signal 118 (i.e. the attenuator control signal). When operated in the non-control station mode, the bias to the LNA 110 is reduced below that of the control station mode, hence the gain of the LNA is reduced, and less (if any) attenuation is needed in the selective attenuator 112. A control signal 119 to the controller 116 can indicate which mode of operation to use, and thereby cause the controller 116 to provide the appropriate control signal(s) 118.

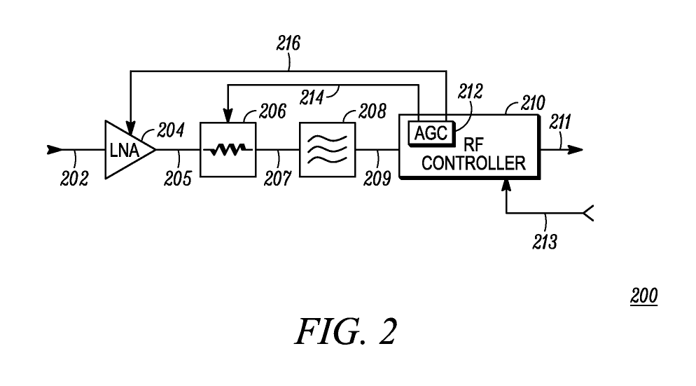

FIG. 2 is a schematic diagram of a receiver front end 200 for a two-way radio device where an automatic gain control component (AGC) 212 controls bias and attenuation in accordance with some embodiments. Similar to the receiver front end of FIG. 1, a LNA 204 receives a filtered RF signal input 202 to produce an amplified output 205 that is fed to a selective attenuator 206. The output 207 of the selective attenuator 206 is filtered 208 to produce a filtered amplified signal 209 that is processed by a controller 210 for demodulation and further signal processing. Accordingly the controller 210 produces an output 211 that does not require further frequency-shift processing. The controller 210 includes an AGC component 212 that operates to maintain the filtered amplified signal 209 at a desired level at an initial processing stage inside the controller 210, such as an analog to digital converter stage. The AGC component 212 can apply a variable gain to the filtered amplified signal 209 The AGC component 212 in some independently control the gain adjustment of the LNA 204 and the attenuation level of the selective attenuator 206 by providing a bias control signal 216 to the LNA 202 and an attenuator control signal 214 to the selective attenuator 206. In addition to gain operations internal to the controller 210, the AGC component 212, as arranged, can independently adjust the bias of the LNA 204, and hence its gain, and the selective attenuator 206, thus expanding the range of gain control that can be effectively applied by the AGC component 212. Furthermore, the AGC component 212 can be controlled internally by the controller 210 responsive to an input control signal 213 from another component of the two-way radio device indicating either a control station mode or a non-control station mode of operation, such that the controller 210 causes the AGC component 212 to adjust the bias of the LNA 204 and the attenuation magnitude of the selective attenuator accordingly.

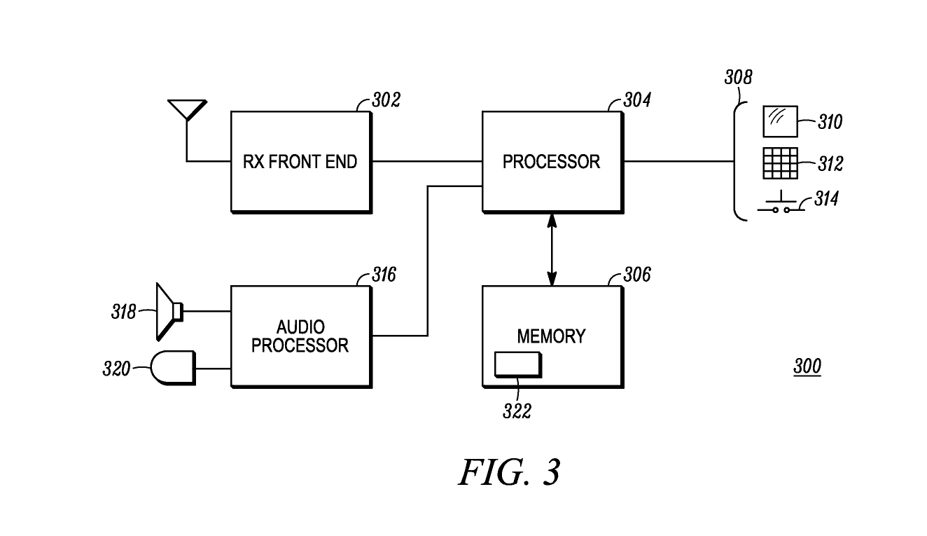

FIG. 3 is a block schematic diagram of a two-way radio device 300 that can be selectively changed between a control station mode and a non-control station mode in accordance with some embodiments. The two-way radio device 300 includes a receiver front end 302 that is the receiver side of a radio transceiver. The receiver front end 302, as in FIGS. 1-2 (100, 200), receives modulated radio signals and down-converts or demodulates the received signals such that no further frequency-shift processing is required, and provides the demodulated signal to a processor 304. The processor 304 performs a variety of functions in the two-way radio device 300, including, for example, the execution of operating system program code, application program code, and so on, as is known. Program code can be stored and instantiated in a memory 306 that is coupled to the processor 304 by a bus. The memory 306 as shown here is an abstraction representing an aggregation of memory types, including read only memory (ROM), random access memory (RAM), non-volatile bulk storage memory such as flash memory, and so on. The processor 304 is further coupled to user interface elements 308, including, for example, a graphical display 310, a keypad 312, and a push to talk button 314. The processor 304 interacts with driver circuitry for each user interface 308 element, as necessary, to provide output and receive input for operating the two-way radio device 300, and allow a user to operate the two-way radio device 300. The graphical display displays information for a user, and can be implemented using any of a number of different types of display technologies, include a liquid crystal display (LCD) or a light emitting diode (LED) display. The keypad 312 can be a plurality of buttons, including “soft keys” on the graphical display 310 in some embodiments, that allow a user to enter information to the two-way radio device 300 for operation of the two-way radio device 300 and for entering information that can be transmitted by the two-way radio device (e.g. Short Message Service text messages). The keypad 312 can further include buttons, knobs and other selectors for settings and selections of radio operation. The push to talk (PTT) button 314 is used to control transmission. Upon pressing the PTT button 314, the two-way radio 300 will commence transmitting audio received by the two-way radio device 300 (e.g. at a microphone 320). Audio is processed by an audio processor 316 that receives acoustic audio signals at a microphone 320 and processes the electric signal produced by the microphone 320 so that the audio information can be transmitted. Furthermore, audio signals received by the receiver 302 are provided to the audio processor 316 which plays the received audio over a speaker 318.

The two-way radio device 300 is capable of operating in either a control station mode or a non-control station mode. A mode selection interface program 322 can be executed by the processor 304, providing a user of the two-way radio device 300 with a means by which the user can select the desired mode of operation. The two-way radio device can have a default operating mode (either control or non-control station mode), or the two-way radio device can store a mode selection and, for example, upon being powered up, resume operating in a last selected mode. Upon entering or changing the mode, the processor 304 can provide appropriate control signals or control information to the receiver front end 302, which then adjusts the LNA bias and selective attenuator accordingly, as previously described herein.

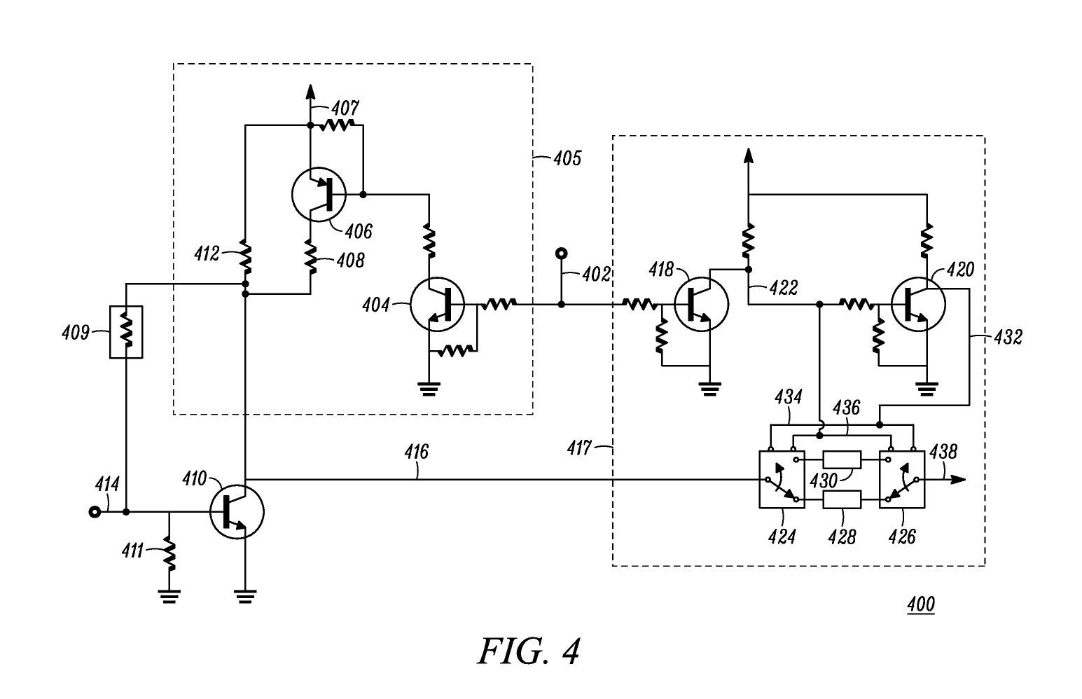

FIG. 4 is a schematic diagram 400 of a bias adjustment network 405 and an adjustable attenuator 417 having a common control signal 402 in accordance with some embodiments. The bias adjustment network 405 changes (adjusts) the bias provided to an amplifying transistor 410 of a LNA, such as LNAs 110, 204 of FIGS. 1 and 2, respectively. In general, the amplifying transistor 410 receives a signal at an input 414 and provides an amplified signal at the output 416. A bias resistor 412 provides a nominal bias current to the amplifying transistor 410 though a bias network of a resistor 409 and resistor 411. Resistor 409 can be a controlled resistance that ensures a constant bias over voltage supply 407 changes as the two-way radio device may operate on battery power. In some embodiments the controlled resistance 409 can comprise a current mirror circuit that provides a constant bias current. The common control signal 402 can be a bistable signal that is either high or low, and is provided to an n-type transistor 404 in the bias adjustment network 405, which in turn drives a p-type transistor 406. When the common control signal 402 is low, the n-type transistor 404 is switched off (not conducting), which prevents the p-type transistor 406 from conducting. When the common control signal 402 is high, the voltage causes n-type transistor 404 to turn on, in turn causing p-type transistor 406 to turn on and conduct through auxiliary bias resistor 408, effectively switching auxiliary bias resistor 408 in parallel with default bias resistor 412, thereby increasing the bias provided to the amplifying transistor 410. When the common control signal 402 is returned to a low state, n-type transistor 404 will shut off, causing p-type transistor 406 to shut off, eliminating current through auxiliary bias resistor 408, and reducing the bias to amplifying transistor 410.

The adjustable attenuator 417 is likewise responsive to the common control signal 402 and generally operates a pair of switches 424, 426 to select one of two or more attenuations networks 428, 430, depending on whether the common control signal 402 is high or low. When the common control signal 402 is low, a first n-type transistor 418 in the adjustable attenuator circuit 417 will be shut off, causing its output 422 to be pulled high, which will cause a second n-type transistor 420 to be turned on, causing its output 432 to be low. Output 422 is provided to a first common switch input 436, and output 432 is provided to a second common switch input 434 of switches 424, 426. Thus, when the common control signal 402 is in one state, one set of corresponding terminals of the switches 424, 426 are selected, causing one of the attenuator networks 428, 430 to be coupled in series between the output 416 of the amplifying transistor 410 and an output 438 of the adjustable attenuator 417. When the common control signal 402 is in the other state, the other set of corresponding terminals of the switches 424, 426 are selected, causing the other one of the attenuator networks 428, 430 to be coupled in series between the output 416 of the amplifying transistor 410 and an output 438 of the adjustable attenuator 417. Accordingly, when the common control signal 402 is low, the default bias is provided to the amplifying transistor 410, and a default attenuation (which can be no attenuation) is coupled in series with the output of the amplifying transistor. Thus, the low state of the common control signal can be used when the two-way radio device is operated in a non-control station mode. When the common control signal 402 is high, corresponding to control station mode, the bias to the amplifying transistor 410 is increased, and a corresponding attenuation is connected in series with the output 416 of the amplifying transistor 410. The common control signal can be both the bias control signal and the attenuation control signal and can be provided by a controller of the receiver front end, as exemplified in FIG. 1.

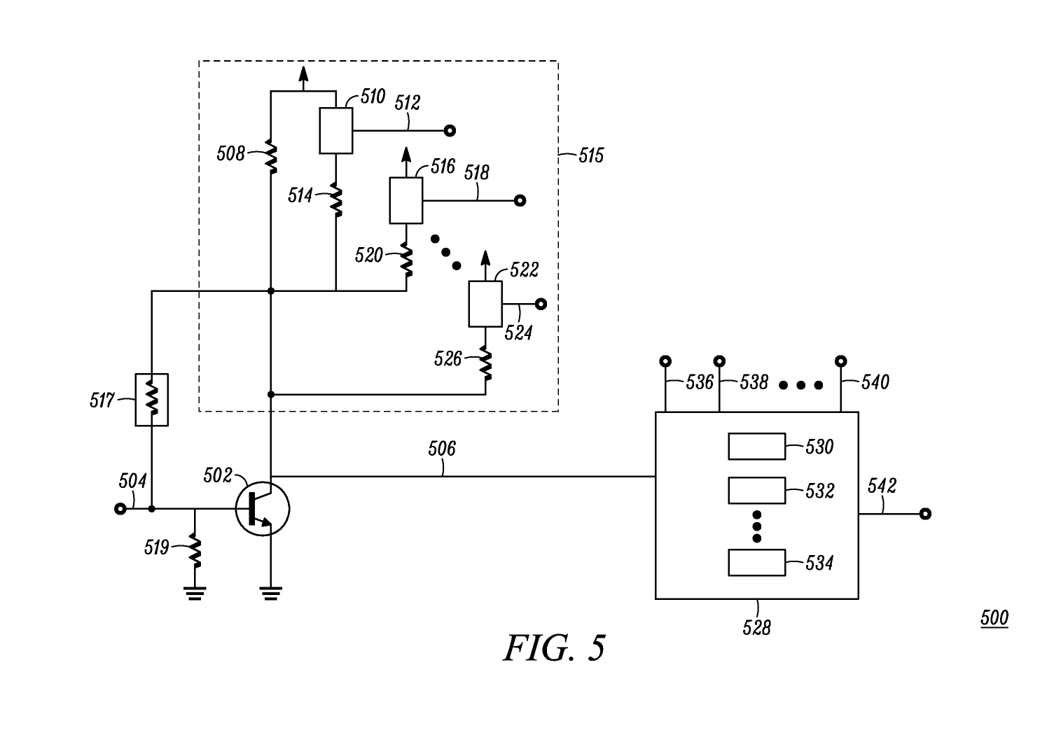

FIG. 5 is a schematic diagram 500 of a bias control circuit 515 and an attenuation switch circuit 528, each controlled by independent control signals in accordance with some embodiments. In the case where an AGC component has control of the bias control signal and the attenuator control signal independently, as exemplified in FIG. 2, there can be more than two selections for each of the bias control circuit 515 and the attenuation switch circuit 528. In some embodiments, rather than a single bistable line, several lines representing a digital word can be provided to the bias control circuit 515, or the attenuation switch circuit 528, or both, independently. An amplifying transistor 502 is supplied with a default bias by default bias resistor 508 that operates with controlled resistance 517 and base resistance 519 to set the bias level to the amplifying transistor 502. A series of bias switch circuits 510, 516, 522, each containing an n-type transistor and a p-type transistor arranged such as transistor 404, 406 of FIG. 4, and each responsive to an input 512, 518, 524, respectively, control auxiliary bias resistors 514, 520, 526, respectively. Each of the auxiliary bias resistors 514, 520, 526 can have different resistance values. Thus, each input 512, 518, 524 can be selected to provide a different amount of additional bias to the amplifying transistor 502. Combinations of the auxiliary bias resistors 514, 520, 526 can be selected as well to further extend the bias choices. The amplifying transistor 502 accordingly amplifies an input signal 504 to provide an output 506 that is provided to the attenuation switch circuit 528. The attenuation switch circuit 528 receives an attenuator control signal that includes a plurality of input lines 536, 538, 540, each of which are used to select one of a plurality of attenuation networks 530, 532, 534 to be connected in series between the output 506 of the amplifying transistor 502, and the output 542 of the attenuation switch circuit 528. By independently selecting bias and attenuation, different levels of signal gain can be realized at the output 542 of the attenuation switch circuit 528 to suit the needs of an AGC component, as well as to meet the needs of operating in either a control station mode or a non-control station mode.

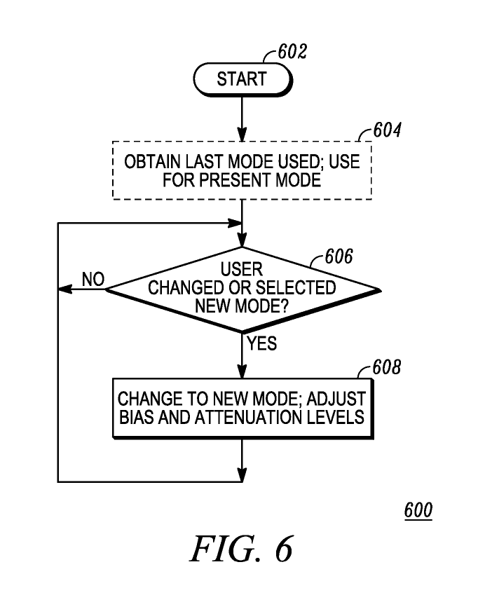

FIG. 6 is a flow chart diagram of a method 600 for operating a two-way radio device and selecting between control station and non-control station modes in accordance with some embodiments. The method can be used to operate a two-way radio device having a receiver front end such as those exemplified in FIGS. 1-2, or a substantially equivalent arrangement. At the start 602, the two-way radio device is powered on and ready for operation. The two-way radio device can default to a mode of operation (either control or non-control station mode), or it can determine a stored setting that indicates a preferred mode of operation, as shown in process 604. Once the initial mode is determined, the receiver front end of the two-way radio device is configured accordingly, with corresponding bias level and attenuation level selected. In some embodiments the bias level provided to the LNA in the control station mode can cause the LNA to have a gain of substantially 3 dB over the gain of the LNA when the LNA is biased for the non-control station mode. The two-way radio device can then, while operating in the mode determined in process 604, essentially wait for a change of mode operation, as indicated in process 606, where the two-way radio device determines if the user wants to change modes. The user can indicate a desired mode change via a user interface, such as a menu, or the change in mode can be detected such as by the connection or disconnection of certain accessories, such as a control station microphone. Various accessories can have coded information that can be read upon connection, or they can be configured to connect to specific accessory ports of the two-way radio device. Once a mode change has been detected, the two-way radio device changes the bias and attenuation selection accordingly, as in process 608, and then resumes waiting for another mode change. The method 600 can continue indefinitely until the two-way radio device is shut off

Accordingly, in some embodiments the receiver front end can be operated by determining a mode of operation of the two-way radio device, which is either a control station mode or a non-control station mode. When the determined mode of operation is the non-control station mode, the receiver front end can be operated by adjusting a bias level of the LNA to a first bias level, and by adjusting the adjustable attenuator (coupled to the output of the LNA) to a first attenuation level. When the determined mode of operation is the control station mode, the receiver front end can be operated by adjusting the bias level of the LNA to a second bias level, and by adjusting the adjustable attenuator to second first attenuation level, the first bias level being lower than the second bias level, and the first attenuation level being a lower attenuation than the second attenuation level.

The embodiments provide the benefit of allowing a two-way radio device to operate in either a control station mode or a non-control station mode. Each mode has different requirements for amplifier linearity, intermodulation response rejection, and blocking in the receiver front end. By increasing the bias to the LNA in the receiver front end in the control station mode (over that of the non-control station mode), the receiver front end will be linear over a wider range of frequencies, and have better intermodulation response rejection. In the non-control station mode, where the bias is lower than that provided in the control station mode, the receiver front end consumes less power, and has improved sensitivity and better blocking.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A receiver front end for a two-way radio device, comprising:
a low noise amplifier that amplifies signals received via an antenna;
a bias adjustment network that adjusts a bias of the low noise amplifier responsive to a bias control signal;
an adjustable attenuator coupled in series with the low noise amplifier that selectively attenuates an output of the low noise amplifier responsive to an attenuation control signal; and
a controller that asserts the bias control signal and the attenuation control signal when the two-way radio device is operated in a control station mode, wherein asserting the bias control signal causes the bias adjustment network to increase bias to the low noise amplifier, and asserting the attenuator control signal causes the adjustable attenuator to increase an attenuation of the output of the low noise amplifier.

2. The receiver front end of claim 1, wherein the bias control signal and the attenuator control signal are not asserted when the two-way radio device is not operated in the control station mode.

3. The receiver front end of claim 1, wherein the attenuator control signal is further controlled by an automatic gain control stage of the controller, and the adjustable attenuator is adjusted via the attenuator control signal to achieve a desired signal gain from the output of the low noise amplifier.

4. The receiver front end of claim 1, wherein the adjustable attenuator provides an attenuated output of the low noise amplifier, and wherein the attenuated output is provided to a demodulator of the two-way radio device.

5. The receiver front end of claim 1, wherein the bias adjustment network increases a linearity of the low noise amplifier when the bias control signal is asserted by the controller.

6. The receiver front end of claim 1, wherein the receiver front end is a direct conversion receiver front end.

7. The receiver front end of claim 1, wherein the controller asserts the bias control signal and attenuation control signal responsive to a user input selecting the control station mode via a user interface of the two-way radio device.

8. The receiver front end of claim 1, wherein the controller asserts the bias control signal and attenuation control signal responsive to a control station accessory being connected to the two-way radio device.

9. The receiver front end of claim 1, wherein the bias control signal is controlled by an automatic gain control stage of the controller, and the bias adjustment network is adjusted via the bias control signal to achieve a desired signal gain of the low noise amplifier.

10. The receiver front end claim 1, wherein the bias control signal and the attenuator control signal are common.

11. A method of operating a receiver front end for a two-way radio device, comprising:
determining a mode of operation of the two-way radio device, wherein the mode of operation is a control station mode or a non-control station mode;
when the determined mode of operation is the non-control station mode, adjusting a bias level of a low noise amplifier to a first bias level, and adjusting an adjustable attenuator coupled to an output of the low noise amplifier to a first attenuation level;
when the determined mode of operation is the control station mode, adjusting a bias level of the low noise amplifier to a second bias level, and adjusting the adjustable attenuator to a second attenuation level; and
wherein the first bias level is lower than the second bias level and the first attenuation level is a lower attenuation than the second attenuation level.

12. The method of claim 11, wherein determining the mode of operation comprises determining a default mode upon powering up the two-way radio device.

13. The method of claim 11, wherein determining the mode of operation comprises receiving a user input at the two-way radio device that indicates a user selectable choice between the control station mode and the non-control station mode.

14. The method of claim 11, wherein determining the mode of operation comprises determining either the connection or disconnection of an accessory associated with the control station mode.

15. The method of claim 11, wherein adjusting the adjustable attenuator to the first attenuation level comprises adjusting the adjustable attenuator to zero attenuation.

16. The method of claim 11, wherein adjusting the bias level of the low noise amplifier to the second bias level causes the low noise amplifier to have a small signal gain of substantially 3 dB over the small signal gain of the low noise amplifier when the low noise amplifier is operated at the first bias level.

17. The method of claim 11, wherein adjusting the bias level of the low noise amplifier and adjusting the attenuation level of the adjustable attenuator are performed using a common control signal provided to both the low noise amplifier and the adjustable attenuator.

18. The method of claim 11, wherein adjusting the bias level of the low noise amplifier and adjusting the adjustable attenuator are performed independently of each other by a bias control signal provided to the low noise amplifier and an attenuation control signal provided to the adjustable attenuator.

19. A two-way radio device operable in either a control station mode or a non-control station mode, comprising:
a processor;
at least one user interface element coupled to the processor that indicates a desired mode of operation of the two-way radio device to the processor;
a receiver front end having a low noise amplifier (LNA) and an adjustable attenuator coupled to an output of the LNA, a bias adjustment network that adjusts a bias of the low noise amplifier responsive to a bias control signal, and a controller that asserts the bias control signal and the attenuation control signal when the two-way radio device is operated in a control station mode, wherein asserting the bias control signal causes the bias adjustment network to increase bias to the low noise amplifier, and asserting the attenuator control signal causes the adjustable attenuator to increase an attenuation of the output of the low noise amplifier, and wherein the controller is responsive to the processor indicating the desired mode of operation to be either the control station mode or the non-control station mode.

20. The two-way radio device of claim 19, wherein the bias level provided to the LNA in the control station mode causes the LNA to have a small signal gain of substantially 3 dB above the small signal gain of the LNA when the LNA is biased to operate in the non-control station mode.
